(19) United States
(12) Patent Application Publication
(10) Pub. No.: US 2005/0113274 A1
(43) Pub. Date: May 26, 2005

(54) Hydrocarbyl aminohydrocarbonoates and aminohydrocarbonol hydrocarbonoates as antimicrobial and antiviral agents

(76) Inventors: Nadir Buyuktimkin, Robbinsville, NJ (US); Servet Buyuktimkin, Robbinsville, NJ (US); James L. Yeager, Lake Forest, IL (US)

Correspondence Address: WELSH & KATZ, LTD, 120 S RIVERSIDE PLAZA, 22ND FLOOR, CHICAGO, IL, 60606, US

(21) Appl. No.: 10/994,591

(22) Filed: Nov. 19, 2004

Related U.S. Application Data
(60) Provisional application No. 60/524,342, filed on Nov. 22, 2003.

(51) Int. Cl. C11D 3/00

(52) U.S. Cl. 510/392

(57) ABSTRACT

A method for providing antimicrobial or antiviral preservation to a liquid-containing composition is disclosed. The method comprises dissolving or dispersing an antimicrobial or antiviral amount of a compound having a molecular weight of about 200 to about 800 Da that is (i) a hydrocarbyl aminohydrocarbonate, (ii) an aminohydrocarbyl hydrocarbonate, (iii) a mixture of (i) and (ii) in that liquid-containing composition. A method of sanitizing a surface is also contemplated that comprises applying a composition prepared by the above method to contact a surface to be sanitized and maintaining that contact for a time sufficient to sanitize the same.

### CROSS-REFERENCE TO RELATED APPLICATION

This application claims benefit from provisional application Ser. No. 60/524,342 filed on Nov. 22, 2003.

### TECHNICAL FIELD

The present invention is related to a method of providing antimicrobial or antiviral activity to a composition, and more particularly to a method for using a hydrocarbyl aminohydrocarbonoate or aminohydrocarbyl hydrocarbonoate, and more particularly a hydrocarbyl N,N-dihydrocarbylaminohydrocarbonoate or N,N-dihydrocarbylaminohydrocarbyl hydrocarbonoate such as an alkyl N,N-dialkylamino alkanoate or N,N-dialkylamino-alkanol alkanoate alone or in admixture with other antimicrobials to provide antimicrobial or antiviral activity to a composition or to a surface to be protected from microbial infestation.

### BACKGROUND ART

Antimicrobial agents are defined as agents that kill or inhibit the growth of microorganisms, whereas antifungal agents are agents that kill or inhibit the growth and reproduction of fungi, molds, and yeasts (Microbiology, Fundamentals and Applications, (1984) Ronald M. Atlas, Macmillan Publishing Company, New York, N.Y., pp. A-8, A-9, and A-43). The new agents described hereinafter adhere to the definitions of antimicrobial agents (antibacterial and antifungal agents) and antiviral agents but are specifically described as new antimicrobial alkanoates. Several antimicrobial agents are well known in the art. Antibiotics, antiseptics, virucides and the like are extensively used in the treatment of various infections in humans, animals and plants. However, due to resistance formation of various microorganisms against well-known agents, new compounds are continuously discovered, tested, and used for improved activity profiles.

The new antimicrobial alkanoates exhibited excellent antimicrobial properties and are effective against bacteria, yeasts, and molds and thus are suitable for use as preservatives or as contact surface antimicrobial agents or antibacterial agents. The new antimicrobial alkanoates can be used to kill and/or inhibit the growth of bacteria, yeasts, molds or viruses on inanimate or animate contact surfaces. The new antimicrobial alkanoates can also be used as antimicrobial agents for treating infections in human, animals or plants due to bacteria, yeasts or molds or viruses.

### BRIEF SUMMARY OF THE INVENTION

Hydrocarbyl aminohydrocarbonoates or aminohydrocarbyl hydrocarbonoates, and more particularly hydrocarbyl N,N-dihydrocarbylaminohydrocarbonoates or N,N-dihydrocarbylaminohydrocarbyl hydrocarbonoate such as an alkyl N,N-dialkylamino alkanoate or N,N-dialkylamino-alkanol alkanoate were initially synthesized as agents to enhance the permeation of various pharmacologically active compounds through various membranes especially skin and were shown to exhibit remarkable enhancement properties in following publications: Büyüktimkin et al. (1995) Int. J. Pharm. 118:113-119; Büyüktimkin et al. (1993) Pharm. Res. 10:1632-1637; Büyüktimkin et al. (1992) Pharm. Res. 9: S 241, PDD 7344; and Wong et al. (1990) U.S. Pat. No. 4,980,378.

These compounds also possess antimicrobial or antiviral properties when utilized in a variety of liquid-containing compositions. A contemplated compound having a molecular weight of about 200 to about 800 Da that is a (i) hydrocarbyl aminohydrocarbonoate or (ii) aminohydrocarbyl hydrocarbonoate or a mixture thereof (iii), and more particularly (i) hydrocarbyl N,N-dihydrocarbylaminohydrocarbonoate, (ii) a N,N-dihydrocarbylaminohydrocarbyl hydrocarbonoate, or (iii) a mixture thereof. A contemplated compound corresponds in structure to general structural Formula I, below
X-Y-A-Z I,
wherein

X is a substituent containing a nitrogen atom and a total of 2 to 20 carbon atoms, wherein said X has the structural formula

R¹R²N— also depicted as

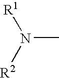

wherein R¹ and R² are the same or different, and are a hydrido (H) group or a hydrocarbyl group that contains one to 10 carbon atoms (C₁-C₁₀ hydrocarbyl) or R¹R²N— together form a ring structure containing 4 to 9 atoms in the ring;

Y is a divalent hydrocarbyl radical containing 1 to 22 carbon atoms (C₁-C₂₂ hydrocarbyl);

A is 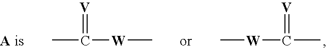
also depicted as —C(V)W— or —WC(V)—, where each of V and W is independently O or S;
and

Z is a monovalent hydrocarbyl radical containing 2 to 30 carbon atoms (C₂-C₃₀ hydrocarbyl),

and wherein the dashes between X, Y, A and Z depict single bonds, as do the dashes used in the structural formulas and alternative depictions except for the carbonyl group that contains a double bond. Illustrative, preferred compounds are alkyl N,N-dialkylamino alkanoates and N,N-dialkylaminoalkanol alkanoates. The use of a pharmaceutically acceptable salt of an above-defined compound of Formula I is also contemplated.

This invention also contemplates the use of the above antimicrobial or antiviral compounds for the sanitization of inanimate surfaces, food or plant material. The contemplated antimicrobial or antiviral compounds are dissolved or dispersed alone in a liquid-containing composition or in suitable liquid formulations or liquid-containing matrices such as gels or creams that contain various natural, semi-synthetic or synthetic polymers as thickening agents, various buffers, active pharmaceutical ingredients and other active and inactive ingredients in either buffered and non-buffered media or matrices. As needed, other acceptable ingredients can be added to improve formulation characteristics or to achieve a desired physical, chemical or clinical characteristic or desired outcome.

### BRIEF DESCRIPTION OF THE DRAWINGS

In the drawings forming a portion of this disclosure,

FIG. 1 is a graph showing the increase of the number of free thiol groups of stratum corneum proteins upon treatment with compositions containing ethanol, dodecyl 2-(N,N-dimethylamino)propionate (DDAIP) and a control.

### DETAILED DESCRIPTION OF PREFERRED EMBODIMENTS

The present invention contemplates antimicrobial (one or both of antibacterial and antifungal) or antiviral use of a compound having a molecular weight of about 200 to about 800 Da that is a (i) hydrocarbyl aminohydrocarbonoate or (ii) aminohydrocarbyl hydrocarbonoate or (iii) a mixture of (i) and (ii) or a pharmaceutically acceptable salt thereof, and more particularly (i) a hydrocarbyl N,N-dihydrocarbylaminohydrocarbonate, (ii) a N,N-dihydrocarbylaminohydrocarbyl hydrocarbonate, (iii) a mixture of (i) and (ii), or a pharmaceutically acceptable salt of (i), (ii) or (iii) present in an antimicrobial or antiviral amount in a liquid-containing composition. A contemplated hydrocarbyl N,N-dihydrocarbylaminohydrocarbonate or N,N-dihydrocarbylaminohydrocarbyl hydrocarbonate corresponds in structure to general structural Formula I
X-Y-A-Z I,
wherein

X is a substituent containing a nitrogen atom and a total of 2 to 20 carbon atoms, wherein said X has the structural formula

R¹R²N— also depicted as

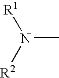

wherein R¹ and R² are the same or different, and are a hydrido (H) group or a hydrocarbyl group that contains one to 10 carbon atoms (C₁-C₁₀ hydrocarbyl) or R¹R²N— together form a ring structure containing 4 to 9 atoms in the ring. X is preferably a substituent containing a triply substituted nitrogen atom so that R¹ and R² are each other than hydrido;.

Y is a divalent hydrocarbyl radical containing 1 to 22 carbon atoms (C₁-C₂₂ hydrocarbyl);

A is 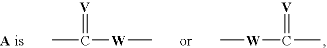
also depicted as —C(V)W— or —WC(V)—, where each of V and W is independently O or S. Preferably, V is O (oxygen), and more preferably, each of V and W is O; and

Z is a monovalent hydrocarbyl radical containing 2 to 30 carbon atoms (C₂-C₃₀ hydrocarbyl),

and wherein the dashes between X, Y, A and Z depict single bonds, as do the dashes used in the structural formulas and alternative depictions except for the carbonyl group that contains a double bond.

Although primary and secondary amino compounds are contemplated, a hydrocarbyl N,N-dihydrocarbylaminohydrocarbonate or N,N-dihydrocarbylaminohydrocarbonol hydrocarbonate is preferred, and such a compound is more preferably an alkyl N,N-dialkylamino alkanoate or dialkylaminoalkanol alkanoate. A contemplated compound more preferably has a molecular weight of about 225 to about 500 Da, and most preferably of about 250 to about 350 Da.

The word “hydrocarbyl” is used herein as a short hand term to include straight and branched chain as well as cyclic aliphatic (saturated and unsaturated non-aromatic) groups or radicals that contain only carbon and hydrogen. Thus, alkyl, alkenyl and alkynyl groups are contemplated, whereas aromatic hydrocarbons such as those containing phenyl and naphthyl groups, which strictly speaking are also hydrocarbyl groups, are excluded. Where a specific aliphatic hydrocarbyl substituent group is intended, that group is recited; i.e., C₁-C₆ alkyl, methyl or dodecenyl. Exemplary hydrocarbyl groups contain a chain of 1 to about 22 carbon atoms, and preferably one to about 18 carbon atoms, and more preferably one to about 10 carbon atoms, and still more preferably for some groups, one to about six carbon atoms; i.e., C₁-C₆.

Usual organic chemical suffices are used with this “hydrocarbyl” nomenclature system so that the prefix “hydrocarbon” used with the suffix -anyl indicates a saturated group, whereas use of the suffix -enyl indicates an olefinic group and use of the suffix -ynyl indicates a triple bond is present in the radical. Similarly, -onoate is used as a suffix for a saturated carboxyl group-containing radical, whereas -enoate indicates an ethylenically unsaturated carboxyl group-containing radical and -ynoate indicates an acetylenically unsaturated carboxyl group-containing radical. Thus, for example, contemplated hydrocarbonate groups include stearate, oleate, linolate, and linolenate.

A particularly preferred monovalent hydrocarbyl radical is a saturated alkyl group, whereas a particularly preferred divalent hydrocarbyl radical is a saturated alkylene group. As a consequence, a generalized, but more preferred substituent can be recited by replacing the descriptor “hydrocarbyl” with “alkyl” or “alkylene” as appropriate in any of the substituent groups enumerated herein.

Examples of alkyl radicals (groups or moieties) include methyl, ethyl, n-propyl, isopropyl, n-butyl, isobutyl, sec-butyl, tert-butyl, pentyl, iso-amyl, hexyl, octyl, hexadecyl, octadecyl, eicosyl and the like. Examples of suitable alkenyl radicals include ethenyl (vinyl), 2-propenyl, 3-propenyl, 1,4-pentadienyl, 1,4-butadienyl, 1-butenyl, 2-butenyl, 3-butenyl, decenyl, hexadecenyl, octadecenyl, eicosenyl and the like. Examples of alkynyl radicals include ethynyl, 2-propynyl, 3-propynyl, decynyl, 1-butynyl, 2-butynyl, 3-butynyl, hexadecynyl, octadecynyl, eicosynyl and the like.

Turning to the above Formula I, one or both of R¹ and R² can be a hydrido group (hydrogen, H—). However, it is preferred that R¹ and R² be the same hydrocarbyl group. It is further preferred that each of R¹ and R² be a straight chained alkyl group having one to about six carbon atoms; i.e. a C₁-C₆ alkyl group, and more preferably a C₁-C₃ alkyl group.

It is preferred that the C₁-C₂₂ divalent hydrocarbyl radical Y also be an alkyl group (alkylene group) that contains two to about eighteen (a C₂-C₁₈ alkylene group), and that the group contain a branch. More preferably, that branch is adjacent to the nitrogen of the X substituent; i.e., the carbon bonded to the nitrogen of the X group is also bonded to two or three other carbon atoms. The branched alkyl group is preferably a secondary alkylene group that contains three to about twelve carbon atoms (C₃-C₁₂ alkylene), and more preferably contains three to about six carbon atoms (C₃-C₆ alkylene). It is also preferred that the Y group be free of cyclic structures.

A in the above structural formula is as —C(V)W— or —WC(V)—, where each of V and W is independently O or S, and each of V and W is preferably O (oxygen), rather than S (sulfur).

The monovalent Z hydrocarbyl radical can containing 2 to 30 carbon atoms (C₂-C₃₀ hydrocarbyl), more preferably contains about 8 to about 20 carbons, and most preferably contains about 10 to about 18 carbon atoms, (C₁₀-C₁₈ hydrocarbyl). This moiety is also preferably an alkyl group that is straight chained; i.e., free of branches or cyclic structures, and is therefore preferably a C₂-C₃₀ alkyl, more preferably a C₈-C₂₀ alkyl, and most preferably a C₁₀-C₁₈ alkyl group.

The term “pharmaceutically acceptable” is used adjectivally herein to mean that the modified noun is appropriate for use in a pharmaceutical product. A contemplated pharmaceutically acceptable salt can be in the form of an amine salt obtained from the tertiary amine present in a contemplated compound and an inorganic or organic acid. Exemplary acid salts include but are not limited to the following: acetate, adipate, alginate, citrate, aspartate, benzoate, benzenesulfonate (besylate), bisulfate, butyrate, camphorate, camphorsulfonate, digluconate, cyclopentane-propionate, dodecylsulfate, ethanesulfonate, formate. glutamate, glucoheptanoate, gluconate, glucurantae, glycerophosphate, hemisulfate, heptanoate, hexanoate, fumarate, hydrochloride, hydrobromide, hydroiodide, 2-hydroxyethanesulfonate, isocitrate, lactate, malate, maleate, methanesulfonate, nicotinate, 2-naphthalenesulfonate, oxalate, oxalacetate, palmoate, pectinate, persulfate, 3-phenylpropionate, phosphate, monohydrogen phosphate, dihydrogen phosphate, picrate, pivalate, propionate, pyruvate, succinate, tartrate, tosylate, mesylate and undecanoate.

In accordance of this invention, a contemplated antimicrobial or antiviral compound described previously is used in an antimicrobial or antiviral amount dissolved or dispersed in a method of providing antimicrobial or antiviral activity to a liquid-containing composition. Various liquid-containing compositions are contemplated including those in which the “liquid” is not readily discernable such as creams or gels. The liquid present is preferably water, but the use of oils (fatty acid esters) and triglycerides that are liquid at room temperature and synthetic liquids such as polyoxyethylene ethers of C₁-C₁₈ hydrocarbons and the like are also contemplated.

Illustrative compositions include aqueous, semisolid creams and emulsion formulations suitable for pharmaceutical, nutraceutical, agricultural, cosmetic, personal care, veterinary care and food products. The preparation of such compositions is well known to those skilled in the art and need not be gone into here.

The results of several published investigations showed alkyl 2-(N,N-dialkylamino)-alkanoates and N,N-dialkylaminoalkanol alkanoates that are the preferred hydrocarbyl N,N-dihydrocarbylaminohydrocarbonoate or N,N-dihydrocarbylaminohydrocarbyl hydrocarbonoate compounds primarily act on the lipid domain of the stratum corneum by creating a disorder as measured by fluorescence anisotropy studies [Turunen et al., (1994), Pharm. Res., 11:289-294]. In addition it was also shown that typical example of this class of enhancer DDAIP, also causes extraction of the lipids of model membranes probably by behaving as a lipophilic solvent [Wolka et al., (2002), AAPS Annual Meeting and Exposition, Toronto, R 6125].

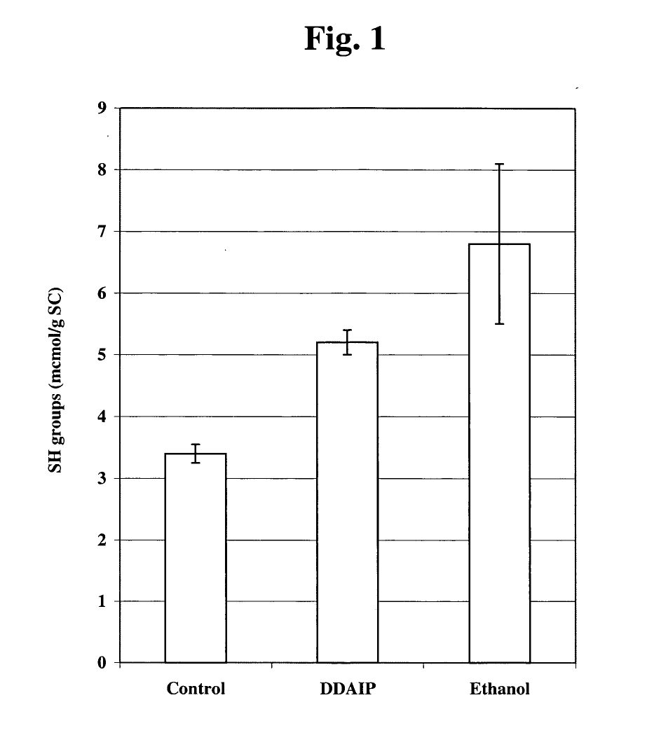

Quite remarkably the study of Büyüktimkin et al., [7^{th} Annual AAPS Meeting and Exposition, San Antonio, (1992) Pharm. Res. 9: S 234, PDD 726], in addition to the effect of dodecyl 2-(N,N-dimethyl amino)propionate to the lipid domain of the stratum corneum, also points out its effect on the protein domain. As shown in FIG. 1, the activity was measured by the increase of the number of free thiol groups of stratum corneum proteins. Typical enhancers, azone (1-dodecylazacycloheptane-2-one or laurocapram) and ethanol were utilized as controls. As expected from these compounds, azone acts on the lipid domain only, and ethanol affects protein domain in addition to the lipid domain. Because azone showed a similar activity to the control it was not included in the chart.

Various contemplated compounds (esters) as described before were formulated into several aqueous and non-aqueous semi-solid formulations suitable for cosmetic, personal care, nutraceutical and pharmaceutical applications but without any pharmacologically active drugs or any additional antimicrobial or antiviral agents. In addition, identical formulations were prepared but without those compounds and these formulations were used as the “placebo” or “control formulations” in comparative experiments. Thus, the compositions contained zero to 5% level one of four (4) representative antimicrobial or antiviral compounds described hereinabove: Dodecyl 2-(N,N-dimethylamino)propionate (DDAIP; Mwt 285), decyl 2-(N,N-dimethylamino)propionate (DeDAIP; Mwt 257), 1-(N,N-dimethylamino)-2-propanol dodecanoate (DAIPD; Mwt 285), 1-(N,N-dimethylamino)-2-propanol tetradecanoate (DAIPM; Mwt 313) and tested for growth inhibitory effect using the USP Antimicrobial Preservatives Effectiveness Test (U.S. Pharmacopeia XXII, <51>, p.1478-1479. All formulations (both with and without a contemplated compound) were kept for 12 months at room temperature and in a refrigerator (2° C. to 8° C.)

At the end of this period, all formulations containing any level of the contemplated compounds passed the requirements of the USP Antimicrobial Preservatives Effectiveness test. Formulations that did not contain a contemplated ester showed extensive mold and fungal growth by visual examination. These observations were totally unexpected because the contemplated compounds are not of part of any class of compounds that had been previously described as exhibiting antimicrobial or antiviral properties.

The antimicrobial activity of the contemplated was evaluated in subsequent studies using the initial 12 month old formulations and in a variety of freshly prepared and stored aqueous semisolid creams and emulsions suitable for pharmaceutical, cosmetic, nutraceutical, personal care and food products using the USP Antimicrobial Preservatives Effectiveness Test (U.S. Pharmacopeia XXII, <51>, p.1478-1479). All formulations containing the new antimicrobial alkanoates, whether freshly prepared or stored for 12 months at room temperature, passed the requirements of the USP Antimicrobial Preservatives Effectiveness Test.

The present invention also includes within the scope thereof a pharmaceutical composition suitable for topical administration having an effective antimicrobial or antiviral amount of a preferred alkyl N,N-dialkylamino alkanoate or dialkylaminoalkanol alkanoate, such as dodecyl 2-(N,N-dimethylamino)propionate (DDAIP), which has following chemical structure.
(CH₃)₂N—CH(CH₃)—CO—O—(CH₂)₁₁—CH₃

Also contemplated herein is the combination of a hydrocarbyl N,N-dihydrocarbylaminohydrocarbonoate or N,N-dihydrocarbylaminohydrocarbyl hydrocarbonoate such as dodecyl 2-(N,N-dimethylamino)propionate with various other known antimicrobial agents. Illustrative known antimicrobials can be found in, for example, Remington's Pharmaceutical Sciences, 18 the ed., A. R. Gennaro ed., Mack Publishing Co. (Easton, Pa., 1990).

Dosage forms include various pharmaceutically acceptable carriers such as creams, gels, ointments. Other dosage forms for topical and local applications can include but not limited to suppositories, pessaries, sprays, powders, solutions, suspensions, aerosols and emulsions and likewise fell into the scope of the present invention. These formulations types can contain all necessary pharmaceutical ingredients such as acceptable solvents including alcohols, polyols, esters, and ethers etc., synthetic, semi-synthetic and natural polymers. The formulations can include but not limited to emulsifiers, antimicrobials, suspending agents, coloring agents, fragrances and other generally regarded as safe (GRAS) ingredients.

An illustrative composition can contain a before-described compound, as well as one or more of a pharmaceutically acceptable thickening and dispersing agent, a solvent, a buffering system, a permeation aid in a scientifically acceptable formulation or carrier matrix. An exemplary dispersing agent is a pharmaceutically acceptable alcohol, polyol or mixtures thereof, preferably ethanol present at up to about 20%. A pharmaceutical aid such as ethyl laurate, isopropyl myristate or similar agent can be present at up to about 20%. A pharmaceutically acceptable thickening agent such as a polymeric compound like a semi synthetic phosphated hydroxyalkyl carbohydrate derivatives, propylene glycol alginates, carbomers, alkyl acrylate copolymers, polyvinyl alcohols and derivatives or natural gums such as locust bean gum, xanthan gum, guar gum can be present at up to about 30% and preferably at about 5%, and more preferably at about 2%. A buffer system is preferably present that maintains the pH value at preferably about pH 4 to about pH 8, and most preferably at about pH 5.5.

The invention further contemplates the incorporation of a contemplated compound into formulations that are useful for application to surfaces and other inanimate objects, as well as application to live plants, or to non-living plant material. Such formulations are sometimes called antibacterial or contact sanitizers. Such formulations are typically aqueous or oil in water emulsions with combinations of cleaning agents, fragrances, emulsifiers and solvents. Initial studies indicate that antibacterial activity is evident in about one minute or less after contact of a composition with a microbe-containing surface.

The invention also contemplates the incorporation of a before described compound into a formulation a contact sanitizer for the application to fresh meat, fish and poultry. Such formulations are typically aqueous and can contain other agents to preserve or maintain freshness of the product.

In a contemplated contact sanitizing use, a contemplated composition as described before is applied to a surface to be sanitized and the contact thus provided is maintained for a time period sufficient to obtain the desired sanitation; i.e., to provide a desired bactericidal of fungicidal effect. As noted elsewhere, that contact can be less than one minute in some circumstances, but contact between the composition and the surface is preferably maintained for a time period of about one to about 30 minutes, and more preferably about 2 to about 10 minutes.

A compound useful in the present invention can be formulated as an antimicrobial or antiviral component of a pharmaceutical composition. Such a composition can then be administered orally, parenterally, by inhalation spray, rectally, or topically in dosage unit formulations containing conventional nontoxic pharmaceutically acceptable carriers, adjuvants, and vehicles as desired. The term parenteral as used herein includes subcutaneous injections, intravenous, intramuscular, intrasternal injection, or infusion techniques. Formulation of drugs is discussed in, for example, Hoover, John E., Remington's Pharmaceutical Sciences, Mack Publishing Co. (Easton, Pa.: 1975) and Liberman, H. A. and Lachman, L., eds., Pharmaceutical Dosage Forms, Marcel Decker (New York, N.Y.: 1980).

Injectable preparations, for example, sterile injectable aqueous or oleaginous suspensions can be formulated according to the known art using suitable dispersing or wetting agents and suspending agents. The sterile inject able preparation can also be a sterile injectable solution or suspension in a nontoxic parenteral acceptable diluent or solvent, for example, as a solution in 1,3-butanediol. Among the acceptable vehicles and solvents that can be employed are water, Ringer's solution, and isotonic sodium chloride solution. In addition, sterile, fixed oils are conventionally employed as a solvent or suspending medium. For this purpose any bland fixed oil can be employed including synthetic mono- or diglycerides. In addition, fatty acids such as oleic acid find use in the preparation of injectables. Dimethyl acetamide, surfactants including ionic and non-ionic detergents, polyethylene glycols can be used. Mixtures of solvents and wetting agents such as those discussed above are also useful.

For therapeutic purposes, formulations for parenteral administration can be in the form of aqueous or non-aqueous isotonic sterile injection solutions or suspensions. These solutions and suspensions can be prepared from sterile powders or granules having one or more of the carriers or diluents mentioned for use in the formulations for oral administration. A contemplated antimicrobial or antiviral compound can be dissolved in water, polyethylene glycol, propylene glycol, ethanol, corn oil, cottonseed oil, peanut oil, sesame oil, benzyl alcohol, sodium chloride, and/or various buffers. Other adjuvants and modes of administration are well and widely known in the pharmaceutical art.

Liquid dosage forms for oral administration can include pharmaceutically acceptable emulsions, solutions, suspensions, syrups, and elixirs containing inert diluents commonly used in the art, such as water. Such compositions can also comprise adjuvants, such as wetting agents, emulsifying and suspending agents, and sweetening, flavoring, and perfuming agents.

The antimicrobial activity of the contemplated was evaluated in subsequent studies using the initial 12 month old formulations and in a variety of freshly prepared and stored aqueous semisolid creams and emulsions suitable for pharmaceutical, cosmetic, nutraceutical, personal care and food products using the USP Antimicrobial Preservatives Effectiveness Test (U.S. Pharmacopeia XXII, <51>, p.1478-1479). All formulations containing the new antimicrobial alkanoates, whether freshly prepared or stored for 12 months at room temperature, passed the requirements of the USP Antimicrobial Preservatives Effectiveness Test.

Although not wishing to be bound by theory, it is believed that the contemplated compounds or their pharmaceutically acceptable salts interact with the cell membranes of various microorganisms resulting in the rapid disruption of the lipid and protein domains, resulting in a loss of integrity of the cell membrane and the death of the microorganism.

### EXAMPLE 1

To test the antimicrobial activity in illustrative formulations, the following compositions were prepared with various amounts of dodecyl 2-(N,N-dimethylamino)propionate (DDAIP) as an exemplary new antimicrobial alkanoate.

| Ingredients | Percent by Weight |
|---|---|
| DDAIP | Zero, 0.5, 1.0, |
| | 2.5, 5 |
| Locust Bean Gum | 0.1-5 |
| Ethanol | 5-10 |
| Isopropyl | 5-10 |
| Myristate (IPM) | |
| pH 5.5, 0.1 M | To 100 |
| phosphate | |
| buffer | |

For the preparation of the formulations, ethanol and isopropyl myristate (IPM; ethyl laurate can also be used) were mixed together. To this mixture dodecyl 2-(N,N-dimethylamino)propionate was added. In a separate stainless steel container containing phosphate buffer locust bean gum was gradually added using a Heidolph overhead mixer equipped with a propeller type blades mounted on to a stainless steel shaft, and stirred under high shear for 2 hours. This was followed by the slow addition of the ethanol, IPM and dodecyl 2-(N,N-dimethylamino)propionate mixture. The resulting system was stirred for an additional 1 hour to give each final formulation.

The formulations prepared in above were assayed for antimicrobial preservative effectiveness as described in the United States Pharmacopeia, Antimicrobial Preservatives Effectiveness Test (U.S. Pharmacopeia XXII, <51>, p.1478-1479. This test utilizes Aspergillus niger, Candida albicans, Pseudomonas aeruginosa, Streptococcus aureus, and Escherichia coli as target organisms. The results of this study demonstrated that the formulations showed remarkable inhibition of growth (Table 1).

Thus, in the presence of Pseudomonas aeruginosa, Aspergillus niger, Candida albicans, Streptococcus aureus, and Escherichia coli after 7 days of study less than 10 cfu/ml remained, with Aspergillus niger this value was observed after 21 days of study. The formulations without the new antimicrobial alkanoates did not exhibit antimicrobial activity in the USP Antimicrobial Preservatives Effectiveness Test. A typical test result is given in Table 1, below.

TABLE 1

| Microorganism | Time (days) | | | | |
|---|---|---|---|---|---|
| (cfu/ml) | Zero | 7 | 14 | 21 | 28 |
| S. aureus | 6.90E+05 | <10 | <10 | <10 | <10 |
| P. aeruginosa | 3.55E+05 | <10 | <10 | <10 | <10 |
| C. albicans | 3.45E+05 | <10 | <10 | — | — |
| A. niger | 3.05E+05 | 1.40E+03 | 3.00E+02 | — | — |
| E. coli | 5.70E+05 | <1 | <1 | — | — |

### EXAMPLE 2

Additional formulations (such as in the examples that follow) were prepared and submitted to visual microorganism growth testing at room temperature (RT) and refrigerator conditions. The examples given below constitute some typical samples of various formulations prepared and tested. During the test period of 2 months no growth was observed with formulations containing dodecyl 2-(N,N-dimethylamino)propionate (DDAIP), whereas all control formulations lacking an antimicrobial agent showed positive growth without exception.

### ILLUSTRATIVE FORMULATION 2

| Ingredients | Weight Percent |
|---|---|
| DDAIP | 10 |
| Pemulen TR-2* | 1 |
| Ethanol | 10 |
| Isopropyl | 10 |
| Myristate | |
| α-Tocopherol | 0.1 |
| Span ®-80** | 0.1 |
| Propylene | 10 |
| Glycol | |
| Triethanolamine | 0.5 |
| EDTA Sodium | 0.02 |
| pH 5.5, 0.1M | Qs to 100 |
| phosphate | |
| buffer | |

*(acrylates/C10-30 acrylate cross polymer).
**Sorbitan oleate.

### ILLUSTRATIVE FORMULATION 3

| Ingredients | % w/w |
|---|---|
| DDAIP | 5 |
| Carbopol 940 | 1 |
| Ethanol | 10 |
| Isopropyl | 10 |
| Myristate | |
| α-Tocopherol | 1 |
| Propylene | 10 |
| Glycol | |
| Trolamine, to | 0.2 |
| adjust the pH | |
| to 5-6 | |
| EDTA Sodium | 0.01 |
| Purified Water | Qs to 100 |

The foregoing description and the examples are intended as illustrative and are not to be taken as limiting. Still other variations within the spirit and scope of this invention are possible and will readily present themselves to those skilled in the art.

Each of the patents and articles cited herein is incorporated by reference. The use of the article “a” or “an” is intended to include one or more.

1. A method for providing antimicrobial or antiviral preservation to a liquid-containing composition that comprises dissolving or dispersing an antimicrobial or antiviral amount of a compound having a molecular weight of about 200 to about 800 Da that is (i) a hydrocarbyl aminohydrocarbonate, (ii) an aminohydrocarbyl hydrocarbonate, (iii) a mixture of (i) and (ii) that corresponds in structure to structural Formula I or a pharmaceutically acceptable salt of (i), (ii) or (iii) in said liquid-containing composition,
X-Y-A-Z I,
wherein
X is a substituent containing a nitrogen atom and a total of 2 to 20 carbon atoms, wherein said X has the structural formula R¹R²N—
wherein R¹ and R² are the same or different, and are a hydrido group or a hydrocarbyl group that contains one to 10 carbon atoms or R¹R²N— together form a ring structure containing 4 to 9 atoms in the ring;
Y is a divalent hydrocarbyl radical containing 1 to 22 carbon atoms;
A is —C(V)W— or —WC(V)—, where each of V and W is independently O or S; and
Z is a monovalent hydrocarbyl radical containing 2 to 30 carbon atoms,
and wherein the dashes between X, Y, A and Z depict single bonds, except for the carbonyl group that contains a double bond.

2. The method according to claim 1 wherein said liquid-containing composition is a pharmaceutical, nutraceutical, cosmetic, personal care, veterinary, agricultural or food product composition.

3. The method according to claim 1 wherein R¹ and R² are the same or different hydrocarbyl group that contains one to 10 carbon atoms or R¹R²N— together form a ring structure containing 4 to 9 atoms in the ring.

4. The method according to claim 1 wherein V is oxygen.

5. The method according to claim 1 wherein W is oxygen.

6. A method for providing antimicrobial or antiviral preservation to a liquid-containing composition that comprises dissolving or dispersing an antimicrobial or antiviral amount of a compound having a molecular weight of about 200 to about 800 Da that is (i) a hydrocarbyl N,N-dihydrocarbylaminohydrocarbonate, (ii) a N,N-dihydrocarbylaminohydrocarbyl hydrocarbonate, (iii) a mixture of (i) and (ii) that corresponds in structure to structural Formula I or a pharmaceutically acceptable salt of (i), (ii) or (iii) in said liquid-containing composition,
X-Y-A-Z I,
wherein
X is a substituent containing a triply substituted nitrogen atom and a total of 2 to 20 carbon atoms, wherein said X has the structural formula
R¹R²N—
wherein R¹ and R² are the same or different hydrocarbyl group that contains 1 to 10 carbon atoms or R¹R²N— together form a ring structure containing 4 to 9 atoms in the ring;
Y is a divalent hydrocarbyl radical containing 1 to 22 carbon atoms;
A is 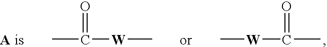
also depicted as —C(O)W— or —WC(O)—, where W is O or S; and
Z is a monovalent hydrocarbyl radical containing 2 to 30 carbon atoms,
and wherein the dashes between X, Y, A and Z depict single bonds, except for the carbonyl group that contains a double bond.

7. The method according to claim 6 wherein said liquid-containing composition is a pharmaceutical, nutraceutical, cosmetic, personal care, veterinary, agricultural or food product composition.

8. The method according to claim 6 wherein said compound is dispersed in said liquid-containing composition.

9. The method according to claim 8 wherein said compound of said dispersion is emulsified, encapsulated or nanoparticulated in said composition.

10. The method according to claim 6 wherein each named hydrocarbyl radical of (i) or (ii) of said compound is a saturated alkyl group when monovalent and a saturated alkylene group when divalent.

11. The method according to claim 6 wherein R¹ and R² are the same.

12. The method according to claim 6 wherein R¹ and R² are each a straight chained C₁-C₆ alkyl group.

13. The method according to claim 6 wherein Y is a C₂-C₁₈ alkylene group.

14. The method according to claim 6 wherein Z is a C₂-C₃₀ alkyl group.

15. The method according to claim 6 wherein W is O.

16. The method according to claim 6 wherein said compound has a molecular weight of about 225 to about 500 Da.

17. A method for providing antimicrobial or antiviral preservation to a liquid-containing composition that comprises dissolving or dispersing as an emulsified, encapsulated or nanoparticulated antimicrobial or antiviral amount of a compound having a molecular weight of about 225 to about 500 Da that is (i) an alkyl N,N-dialkylaminoalkanoate, (ii) a dialkylaminoalkanol alkanoate, (iii) a mixture of (i) and (ii) that corresponds in structure to structural Formula I or a pharmaceutically acceptable salt of (i), (ii) or (iii) in said liquid-containing composition,
X-Y-A-Z I,
wherein
X is a substituent containing a triply substituted nitrogen atom and a total of 2 to 20 carbon atoms, wherein said X has the structural formula R¹R²N—;
wherein R¹ and R² are the same and are each a straight chained C₁-C₆ alkyl group;
Y is a C₂-C₁₈ alkylene group;
A is —C(O)O— or —OC(O)—; and
Z is a C₂-C₃₀ alkyl group,
and wherein the dashes between X, Y, A and Z depict single bonds, except for the carbonyl group that contains a double bond.

18. The method according to claim 17 wherein said antimicrobial or antiviral compound is present in combination with one or more additional antimicrobial compounds of other than Formula I.

19. The method according to claim 17 wherein R¹ and R² are the same and are each a straight chained C₁-C₃ alkyl group.

20. The method according to claim 17 wherein Y is a C₃-C₁₂ alkylene group.

21. The method according to claim 20 wherein Y is branched and the branch is adjacent to the nitrogen of the X substituent.

22. The method according to claim 17 wherein Z is a C₈-C₂₀ alkyl group.

23. The method according to claim 22 wherein Z is straight chained.

24. The method according to claim 17 wherein said compound is present in an amount of about 0.1 to about 5%.

25. The method according to claim 17 wherein said compound has a molecular weight of about 250 to about 350 Da.

26. The method according to claim 17 wherein said antimicrobial or antiviral compound is dodecyl 2-(N,N-dimethylamino)propionate, decyl 2-(N,N-dimethylamino)propionate, 1-(N,N-dimethylamino)-2-propanol dodecanoate, or 1-(N,N-dimethylamino)-2-propanol tetradecanoate.

27. A method for sanitizing a surface that comprises contacting a surface to be sanitized with a composition prepared by the method of claim 1 and maintaining said contact for a time period sufficient to sanitize said surface.
